(19) United States
(12) Patent Application Publication
(10) Pub. No.: US 2009/0000736 A1
(43) Pub. Date: Jan. 1, 2009

(54) Oxidant-Containing Adhesive Enabling Disassembly

(75) Inventor: Yoshiaki Mitarai, Tokyo (JP)

Correspondence Address: STAAS & HALSEY LLP, SUITE 700, 1201 NEW YORK AVENUE, N.W., WASHINGTON, DC, 20005, US

(73) Assignee: Asahi Kasei Chemicals Corporation, Tokyo (JP)

(21) Appl. No.: 12/087,972

(22) PCT Filed: Jan. 11, 2007
(86) PCT No.: PCT/JP2007/050258

§ 371 Date: Jul. 18, 2008

(30) Foreign Application Priority Data
Jan. 19, 2006 (JP) 2006-010635

(51) Int. Cl. B32B 38/10; C08L 71/12; B29C 65/50

(52) U.S. Cl. 156/330; 525/396; 156/344

(57) ABSTRACT

An object of the present invention is to provide an easily disassemblable adhesive that is an adhesive for forming a structure by adhering members and enables easy disassembly of the adhered structure owing to possessing disassemblability. The invention provides a disassemblable adhesive containing an organic adhesive component and an oxidant.

### TECHNICAL FIELD

The present invention relates to a disassemblable adhesive that enables easy disassembly of a structure or article assembled with an adhesive, at its adhered part.

### BACKGROUND ART

As an adhesive, including a structural adhesive, there has been demanded one stronger in adhesive force, longer in durability and further strong in heat resistance and against fluctuations of the temperature environment, and development thereof has been advanced. However, in respect to recycling that intends to effectively use limited resources, development of a disassemblable adhesive is indispensable for reuse of assembled parts.

The disassemblable adhesive is one that makes it possible to debond a bonded part by treatment of some kind after the period of use. As such an adhesive, according to a thermoplastic adhesive, it is possible to disassemble the bonded part by heating. However, once cooled, adhesion force is restored again. In the case of disassembly, it is difficult to heat only the adhesive, so that disassembly is performed at high atmospheric temperature. It has therefore been highly dangerous to disassemble a bonded article whose temperature is elevated to high temperature. In order to solve this problem, development has been advanced for thermally expandable microballoon, thermally expandable graphite, degradable polymer (polyperoxide) or the like which is also applicable to a thermosetting adhesive required to have adhesion force stronger than the thermoplastic adhesive (see non-patent document 1). However, there have been left such problems that the thermally expandable microballoon is still low in heat resistance and initial adhesion strength, that the thermally expandable graphite is difficult to be used in a practical adhesive thickness because of its large particle size, and that the heating temperature at the time of disassembly is high (see patent document 2).

However, the greatest problem in attempts to impart disassemblability to the adhesive is that after the addition of external stimulation such as heating, adhesion force remains after cooling. Even when it is intended to thermally deteriorate or thermally decompose the adhered part by heating or the like to disassemble the adhered structure, no oxygen is supplied thereto because of its hermetically closed space. Accordingly, adhesion force remains even when it is exposed to considerably high temperature. Further, in some cases, so-called seizing occurs, and disassembly is extremely difficult. For this reason, when it is intended to disassemble the adhered structure by heating, high temperature becomes necessary, and when a structure of metal/FRP (fiber reinforced plastic) or the like is disassembled, the function or structure of FRP is lost. Accordingly, this has posed a serious problem for the needs of recycling.

Further, from recent demands for energy saving of automobiles, there is a trend of replacing metal parts by FRP for weight saving of the automobiles, and from the drawback of FRP of being easily broken, there has been conceived a method of molding metal and FRP in laminated form. However, in the case of such a laminated product, disassembly is particularly difficult, which has posed a problem.

[Non-Patent Document 1] Chiaki Sato, Polymer, June, 390 (2005)

[Patent Document] JP-A-2004-189856

### DISCLOSURE OF THE INVENTION

### Problems that the Invention is to Solve

An object of the invention is provide an adhesive that is capable of disassembling an adhered part at relatively low temperature by external stimulation in case of necessity without decreasing initial strength after adhesion, and that is disassemblable even after cooling.

### Means for Solving the Problems

In order to overcome the above-mentioned problems of the conventional art, the present inventors have made extensive studies. As a result, the inventors have found out that an oxidant is incorporated to an adhesive, thereby decomposing the oxidant by external stimulation, and that an adhesive component is burnt with oxygen generated, thereby minimizing residual strength of the adhesive or allowing it to completely disappear, thus coming to complete the invention.

That is, the invention provides a disassemblable adhesive, an adhering method and a disassembling method as described below.

(1) A disassemblable adhesive comprising an organic adhesive component and an oxidant.

(2) The disassemblable adhesive of the above-mentioned (1), wherein the above-mentioned oxidant is an oxidant that exothermically decomposes under hermetically closed conditions.

(3) The disassemblable adhesive of the above-mentioned (1) or (2), wherein the above-mentioned oxidant is a perchloric acid-based oxidant.

(4) The disassemblable adhesive of any one of the above-mentioned (1) to (3), wherein the particle size of the above-mentioned oxidant is 100 μm or less.

(5) The disassemblable adhesive of any one of the above-mentioned (1) to (4), wherein the adhesive further comprises a decomposition accelerator.

(6) The disassemblable adhesive of the above-mentioned (5), wherein the decomposition accelerator is at least one member selected from a metal oxide such as a chromate, MnO₂, Fe₂O₃, nBF (normal-butylferrocene), DnBF (dinormal-butylferrocene), FeO(OH), ferrous oxide, magnesium oxide, copper oxide, cobalt oxide or copper chromite, a compound containing a metal in its molecule such as ferrocene, dimethylferrocene or ferrosilicon, and activated carbon.

(7) The disassemblable adhesive of any one of the above-mentioned (1) to (6), wherein the adhesive further comprises an exothermic agent.

(8) The disassemblable adhesive of the above-mentioned (7), wherein the exothermic agent is at least one member selected from an azido group-containing compound such as a 3-azidomethyl-3-oxetane polymer (AMMO), a glycidylazido polymer (GAP) or a 3,3-bisazidomethyloxetane polymer (BAMO), azodicarbonamide, a metal salt of azodicarbonamide, urea, guanidine nitrate, biscarbamoylhydrazine, p,p′-oxybisbenzenesulfonylhydrazide, dinitropentamethylenetetramine, p-toluenesulfonylhydrazide, benzenesulfonylhydrazide, dinitropentamethylenetetramine, trimethylenetrinitroamine (RDX), tetramethylenetetranitroamine (HMX), urazole, a triazole and a tetrazole.

(9) An adhering method comprising adhering an adherend and an adherend with the disassemblable adhesive of any one of the above-mentioned (1) to (8).

(10) The disassemblable adhesive of the above-mentioned (9), wherein one adherend is metal and the other adherend is FRP.

(11) A disassembling method comprising carbonizing by external stimulation a binding site of an adhered structure adhered by the adhering method described in the above-mentioned (9) or (10) to allow adhesion strength to disappear.

(12) The disassembling method of the above-mentioned (11), wherein the external stimulation is heating.

### Advantages of the Invention

According to the disassemblable adhesive of the invention, it becomes possible to easily disassemble by external stimulation an adhered structure adhered using this adhesive.

### BEST MODE FOR CARRYING OUT THE INVENTION

In the disassemblable adhesive of the invention, adhesion properties decreases or disappears by external stimulation, so that it becomes possible to easily disassemble an adhered structure adhered using this adhesive.

The external stimulation referred to in this specification means physical stimulation such as heat or fire, and more specifically, it includes hot air heating, infrared irradiation, high frequency heating, chemical reaction heat, frictional heat and heating with fire using a gas burner or the like. When the above-mentioned external stimulation is given to the adhered structure adhered with the adhesive of the invention, oxygen in an oxidant promotes thermal decomposition and burning of the adhesive by receiving the stimulation to accelerate carbonization of the adhesive, compared to the case where the oxidant is not added, thereby being able to significantly decrease adhesion force or to allow it to disappear, in addition to the phenomenon that the temperature of the adhesive increases to decrease adhesion force of an adhesive component.

In terms of uniform heating of a large-scaled adhered structure, a method of heating the structure in an internal space of an apparatus such as an electric furnace or a gas furnace, which has a heating unit as an internal structure and the outside of which is constituted by a heat insulating material, is more preferred. Further, as for the temperature at the time of disassembly, it is an extremely important problem to make it possible to disassemble a metal/FRP bonded body, an FRP/FRP bonded body or the like at a temperature equal to or less than the melting point of the FRP for a short period of time. For example, when reuse is taken into consideration in disassembly of an adhered structure of a resin used in a composite material, such as PPS (polyphenylene sulfide, melting point: 280° C.) or PEEK (polyetheretherketone, melting point: 335° C.), it is important, in order to cause no deterioration of the resin, not to perform heating to the resin at a temperature equal to or more than the melting point for a long period of time. The heating temperature is preferably 350° C. or less, and more preferably 300° C. or less.

Although the adhesive component that can be utilized in the invention is not limited at all, it is preferred to use a structural adhesive, because the gist of the invention resides in disassembling one that is difficult to be disassembled. The structural adhesive is “an adhesive in which the reliability of being able to apply a stress relatively near to its maximum rupture load without rupture for a long period of time is assured” (see Adhesive Application Technique, page 93, Classification of Adhesives, published by Nikkei Gijyutsu Tosho Co., Ltd. (1991)), and according to the classification by chemical compositions (the same book, page 99), thermosetting adhesives and alloys are preferred.

When organic adhesive components that can be used in the disassemblable adhesive of the invention are exemplified, they include an adhesive mainly comprising a vinyl acetate resin, a polyamide resin, a polyurethane resin, a polyester resin, a urea resin, a melamine resin, a resolsinol resin, a phenol resin, an epoxy resin, a polyimide resin, polybenzimidazole, acryl (SGA), an acrylic diester, a silicone rubber-based resin or the like. As the alloy, there can be used an epoxyphenolic, an epoxy-polysulfide, an epoxy-nylon, a nitrile-phenolic, a chloroprene-phenolic, a vinyl-phenolic or the like, or a resin obtained by modifying the above-mentioned materials or a resin obtained by mixing two or more of the above-mentioned materials. In particular, the epoxy resin-based adhesive is preferred because it is cured without librating a by-product and has high shear strength. A bisphenol A type epoxy resin and a bisphenol F type epoxy resin are particularly preferred in terms of reactivity and workability.

In the case of the structural adhesive, one indicating a value of 10 MPa or more when tensile strength measurement as shown in the Examples is made at normal temperature is preferred.

A common definition of the oxidant is a material having an oxidative effect, and classified into 1) one giving oxygen, 2) one taking away hydrogen, 3) one increasing the positive oxidation number and 4) one taking away an electron. Of the ones thus defined, the oxidant as referred to in the invention is the “one giving oxygen” of 1), and may be any as long as it librates oxygen by external stimulation. Specifically, there are a perchlorate (for example, ammonium perchlorate, potassium perchlorate, sodium perchlorate, lithium perchlorate or the like), a chlorate (potassium chlorate, lithium chlorate, sodium chlorate, magnesium chlorate or the like), a nitrate (ammonium nitrate, potassium nitrate, sodium nitrate, strontium nitrate, basic copper nitrate or the like), a metal peroxide (calcium peroxide, potassium peroxide or the like), a nitrite, a bromate, a chromate, a permanganate, a sulfate and the like. Two or more thereof may be used in combination.

It is preferred that the oxidant exothermically decomposes under hermetically closed conditions. The adhesive is disassembled by thermal decomposition of the adhesive and the oxidant, so that use of the oxidant that exothermically decomposes under hermetically closed conditions can accelerate disassembly of the adhesive. The oxidant that exothermically decomposes under hermetically closed conditions as referred to herein means an oxidant that exothermically decomposes when measurement is made with a differential scanning calorimetric analyzer using a hermetically closed cell.

Further, the oxidant is used as a mixture with the adhesive component, so that solid powdery one is preferred. However, it may be an oxidant that is liquid under normal temperature and normal pressure and compatible with the adhesive component.

The perchlorate-based oxidant, particularly ammonium perchlorate used as an oxidant for a rocket, is more preferred, because it exothermically decomposes under hermetically closed conditions, easily available, and high in safety when pulverization is required (when mixed with the adhesive or when the viscosity of the adhesive is adjusted). Further, the nitrate is environmentally preferred, because a decomposed gas thereof is mainly composed of nitrogen.

In the invention, a decomposition accelerator may be incorporated to the adhesive together with the oxidant.

The decomposition accelerator as referred to in this specification means one that accelerates decomposition reaction of the oxidant when used in combination with the oxidant, and is a substance that accelerates decomposition of the oxidant by catalytic action for decomposition of the oxidant and improvement in thermal conductivity.

For example, it has been known that decomposition of ammonium nitrate is accelerated with a chromate, and that ammonium perchlorate is accelerated with MnO₂ or Fe₂O₃ (see “Rocket Engineering”, pages 230 and 231, Nikkan Kogyo Shinbun, Ltd., published on Mar. 25, 1960).

In addition, there have been known nBF (normal-butylferrocene), DnBF (dinormal-butylferrocene), FeO(OH) and the like (see Itsuro Kimura, “Rocket Engineering”, page 523, Yokendo, published on Jan. 27, 1993).

The decomposition accelerator is used in combination with the oxidant and mixed with the adhesive to use, so that one that is solid powdery or liquid at normal temperature is preferred. Besides, it accelerates decomposition of the oxidant by utilizing good thermal conductivity of metal as a function, so that a metal-containing compound is preferred. Specifically, in addition to the compounds described in the above-mentioned reference document, there can be used a pulverizable metal oxide such as ferrous oxide, magnesium oxide, copper oxide, cobalt oxide or copper chromite, and a compound containing a metal in its molecule such as ferrocene, dimethylferrocene or ferrosilicon. Further, activated carbon having catalytic action caused by its fine surface structure can also be used. These may be used as a combination of two or more thereof.

Further, in the invention, an exothermic agent may be incorporated to the adhesive together with the oxidant, or the oxidant and the decomposition accelerator. The exothermic agent as referred to in this specification is one that decomposes itself while generating heat when it reaches a decomposition temperature, and can accelerate thermal decomposition and burning of the adhesive containing the above-mentioned oxidant or containing the oxidant and the decomposition accelerator, or can decrease the atmospheric temperature at the time when the adhesive containing the above-mentioned oxidant or containing the oxidant and the decomposition accelerator is disassembled. Specifically, there can be used azodicarbonamide, a metal salt of azodicarbonamide, urea, guanidine nitrate, biscarbamoylhydrazine, p,p′-oxybisbenzenesulfonylhydrazide, dinitropentamethylenetetramine, p-toluenesulfonylhydrazide, benzenesulfonylhydrazide, dinitropentamethylenetetramine, trimethylenetrinitroamine (RDX), tetramethylenetetranitroamine (HMX), urazole, a triazole, a tetrazole and the like, as well as an azido group-containing compound such as a 3-azidomethyl-3-oxetane polymer (AMMO), a glycidylazido polymer (GAP) or a 3,3-bisazidomethyloxetane polymer (BAMO). As described above, these accelerate thermal decomposition and burning of the adhesive containing the oxidant or containing the oxidant and the decomposition accelerator to decrease the disassembling temperature, so that a temperature similar to or lower than the decomposition temperature of the oxidant is preferred.

The oxidant, the decomposition accelerator and the exothermic agent may be either previously incorporated to the adhesive component, or mixed at the time of use of the adhesive when they have a problem with respect to long-term stability in the adhesive before curing.

As the amount of the oxidant added, the weight ratio of the adhesive component and the oxidant is preferably from 100/1 to 2/3 from viewpoints of disassemblability, initial strength of the adhesive and viscosity of the adhesive. When the amount of the oxidant is too small, the disassemblability decreases. When the amount of the oxidant is too large, a decrease in initial strength and a viscosity rise of the adhesive become significant. The weight ratio of the adhesive component and the oxidant is more preferably from 75/1 to 2/1, and further preferably from 50/1 to 3/1.

In the case where the decomposition accelerator is to be added, the weight ratio of the oxidant and the decomposition accelerator is preferably from 50/1 to 1/5 from viewpoints of disassemblability and heat resistance of the adhesive. When the amount added is too small, the effective decomposition accelerating effect is not obtained. When the amount added is too large, a decrease in heat resistance of the adhesive becomes significant. The weight ratio of the adhesive component and the oxidant is more preferably from 45/1 to 1/3, and further preferably from 40/1 to 1/2.

In the case where the exothermic agent is to be added, the weight ratio of the oxidant and the exothermic agent is preferably from 1/1 to 1/100 from the viewpoint of disassemblability. The weight ratio of the oxidant and the exothermic agent is more preferably from 1/2 to 1/80, and further preferably from 1/3 to 1/50.

Further, even when the oxidant is used together with the decomposition accelerator and the exothermic agent, the weight ratio of the adhesive component (component A) and the total amount (component B) of the oxidant, the decomposition accelerator and the exothermic agent is preferably 2/3 or less from the viewpoints of initial strength of the adhesive and viscosity of the adhesive.

As for the particle size, the thickness of the adhesive is generally about 1 mm at the maximum, so that in the oxidant, the decomposition accelerator and the exothermic agent, the particle size is preferably 1 mm or less. Further, when the particle size becomes fine, the surface area increases to improve reactivity with the adhesive and to improve dispersibility in the adhesive. It is therefore preferably 100 μm or less, more preferably 50 μm or less, still more preferably 20 μm or less, yet more preferably 10 μm or less, and yet still more preferably 5 μm or less. In this specification, the particle size means the median size measured using a laser diffraction type particle size distribution.

Although a place in which the adhesive of the invention is used is not particularly limited, it is possible to use for recycling, reuse and rework applications, and the adhesive can be suitably used for adhesion of different materials such as metal-FRP or metal-glass. Further, it is also possible to use for adhesion of different types of metal-metal or FRP-FRP.

### EXAMPLES

In order to demonstrate the advantages of the invention, the following experiments were conducted.

### Preparation of Adhesive

As the structural adhesive, an epoxy resin-based adhesive widely employed was used. The epoxy resin-based adhesive used was prepared as described below.

As a base resin, bisphenol F type epoxy (manufactured by Asahi Denka Kogyo K.K., Adeka Resin EP-4901), butyl glycidyl ether (manufactured by NOF Corporation, Epiol B-4) and 1,6-hexanediol diglycidyl ether (manufactured by Asahi Denka Kogyo K.K., Adeka Glycilol ED-529E) were mixed at a composition ratio of 85/5/10 to obtain epoxy resin main component (A). As a curing agent, modified aliphatic polyamine (manufactured by Asahi Denka Kogyo K.K., Adeka Hardener EH-463) (B) was used. As composition formulation for adhesion curing, A/B=100/35 were mixed to obtain an adhesive composition (base adhesive).

In order to show the advantages of the invention, there were prepared one composed of only the base adhesive (formulation composition 1), one in which AP (ammonium perchlorate) (particle size: 10.08 μm) was incorporated as the oxidant into the base adhesive (formulation composition 2), one in which AP (ammonium perchlorate) (particle size: 10.08 μm) as the oxidant and diiron trioxide (1.41 μm) as the decomposition accelerator (thermal conductive material) were incorporated (formulation composition 3), and one in which AP (ammonium perchlorate) (particle size: 10.08 μ) as the oxidant and GAP (glycidylazido polymer) as the exothermic agent were incorporated (formulation composition 4), respectively, as shown in Table 1. Also, one in which thermally expandable graphite is incorporated (formulation composition 5) and one in which thermally expandable microballoon is incorporated, which are analogous techniques, were each prepared.

TABLE 1

| | Formulation | Formulation | Formulation | Formulation | Formulation | Formulation |
|---|---|---|---|---|---|---|
| | Composition | Composition | Composition | Composition | Composition | Composition |
| | 1 | 2 | 3 | 4 | 5 | 6 |
| Base Adhesive | 100 | 100 | 100 | 100 | 100 | 100 |
| AP | | 10 | 10 | 10 | | |
| Fe₂O₃ | | | 5 | | | |
| GAP | | | | 5 | | |
| Thermally | | | | | 25 | |
| Expandable | | | | | | |
| Graphite | | | | | | |
| Thermally | | | | | | 30 |
| Expandable | | | | | | |
| Microballoon | | | | | | |

### Measurement of Adhesion Strength

For measurement of adhesion strength, an adhesive composition having the above-mentioned composition was applied to a circular sectional portion of a columnar metal chip (weight: 139.5 g, made of SUS) having a diameter of about 2.85 cm, sandwiched with a metal chip having the same shape, and cured by heating with a heating apparatus at 100° C. for 2 hours to obtain an adhered structure sample. Tensile strength (strength before heating) of the resulting sample was measured at a measuring temperature of 25° C. and a tensile rate of 5 mm/min. The results of measurement are shown in Table 2.

### Electric Furnace Peel Test

Heating for a peel test (excluding Comparative Example 3) was performed using an electric furnace. The test piece was placed in the heating furnace whose atmosphere was adjusted to 280° C., and ascertainment of peeling was conducted for every 10 minutes. For one finally heated for 1 hour, tensile strength was obtained under the same conditions as described above. In the test, the following tester was used.

### Tester

SHIMADZU (manufactured by Shimadzu Corporation), type: AG-10TD, load cell: for 10 tons (100000 N)

### Comparative Example 1

An adhered structure sample adhered with the base composition of formulation composition 1 was heated at 280° C., and the degree of peeling due to heating was ascertained. The results thereof are shown in Table 2. As a result of the test, no peeling was observed. That is, one of the chips used in the test was pinched and lifted up, but no separation occurred even when returned to normal temperature.

### Example 1

An adhered structure sample adhered using formulation composition 2 was heated at 280° C., and the degree of peeling due to heating was ascertained. The results thereof are shown in Table 2. Peeling was ascertained 50 minutes after it was placed in the electric furnace. (The evaluation of this case was expressed as “Good” in a column of peelability in Table 2.) The degree of carbonization was B. Carbonization of the adhesive is considered to be indispensable for peeling.

### Example 2

An adhered structure sample adhered using formulation composition 3 was heated at 280° C., and the degree of peeling due to heating was ascertained. The results thereof are shown in Table 2. It was ascertained that the test piece was peeled 30 minutes after it was placed in the electric furnace. From this result, it was demonstrated that use of diiron trioxide as the decomposition accelerator in combination with the oxidant caused heat as external stimulation to be more effectively conducted to the adhered part upon heating, and was effective for peeling. The degree of carbonization was A. Carbonization of the adhesive is still considered to be indispensable for peeling.

### Example 3

An adhered structure sample adhered using formulation composition 4 was heated at 280° C., and the degree of peeling due to heating was ascertained. The results thereof are shown in Table 2. It was ascertained that the test piece was peeled 30 minutes after it was placed in the electric furnace. From this result, it was demonstrated that use of GAP (glycidylazido polymer) as the exothermic agent in combination with the oxidant by heat generation at the time of decomposition of the exothermic agent. The degree of carbonization was A. Carbonization of the adhesive is still considered to be indispensable for peeling.

### Comparative Example 2

An adhered structure sample adhered using formulation composition 5 was heated at 280° C., and the degree of peeling due to heating was ascertained. The results thereof are shown in Table 2. It was ascertained that the test piece was peeled after 60 minutes. However, the strength before heating expressed was only about 60% as compared to formulation composition 1 as the base composition, and a problem that thermally expandable graphite was high in disassembling temperature and low in initial strength became clear.

### Comparative Example 3

An adhesive of formulation composition 6 was immersed in hot water of 90° C. The results thereof are shown in Table 2. It was ascertained that the test piece was peeled after a period of time after immersion in hot water. However, the initial strength was less than 10% as compared to the base composition. From that peeling occurred under heating conditions of 90° C., heat resistance was also low, and it became clear that it was difficult to use in the structural adhesive.

TABLE 2

| | Formulation Composition | | | | | |
|---|---|---|---|---|---|---|
| | Comparative | | | | Comparative | Comparative |
| | Example 1 | Example 1 | Example 2 | Example 3 | Example 2 | Example 3 |
| Heating Conditions | 280 | 280 | 280 | 280 | 280 | 90 |
| (° C.) | | | | | | |
| Peelability | Bad | Good | Good | Good | Good | Good |
| Peeling Time | — | 50 min | 30 min | 30 min | 60 min | 1 min |
| Degree of | D | B | A | A | C | — |
| Carbonization | | | | | | |
| Strength before | 14.18 | 12.14 | 16.98 | 12.65 | 9.1 | 1.4 |
| Heating MPa | | | | | | |
| Strength after | 8.57 | — | — | — | — | — |
| Heating MPa | | | | | | |

### Degree of Carbonization

A: Sufficiently carbonized and having no luster.

Powdery and smooth to the touch by hand.

B: Almost carbonized, but luster partially remains.

C: Scarcely carbonized, and transparency remains.

Being darkish.

D: Not carbonized, and having luster and transparency. Discolored to brown.

While the invention has been described in detail and with reference to specific embodiments thereof, it will be apparent to one skilled in the art that various changes and modifications can be made therein without departing from the spirit and scope thereof.

This application is based on Japanese Patent Application No. 2006-010635 filed on Jan. 19, 2006, the contents of which are incorporated herein by reference.

### INDUSTRIAL APPLICABILITY

According to the disassemblable adhesive of the invention, it becomes possible to easily disassemble by external stimulation the adhered structure adhered using this adhesive. Accordingly, the adhesive of the invention is useful for recycling, reuse and rework applications, and can be suitably used for adhesion of different materials such as metal-FRP or metal-glass.

1. A disassemblable adhesive comprising an organic adhesive component and an oxidant.

2. The disassemblable adhesive according to claim 1, wherein the oxidant is an oxidant that exothermically decomposes under hermetically closed conditions.

3. The disassemblable adhesive according to claim 1, wherein the oxidant is a perchloric acid-based oxidant.

4. The disassemblable adhesive according to claim 1, wherein the particle size of the oxidant is 100 μm or less.

5. The disassemblable adhesive according to claim 1, wherein the adhesive further comprises a decomposition accelerator.

6. The disassemblable adhesive according to claim 5, wherein the decomposition accelerator is at least one member selected from the group consisting of a chromate, manganese oxide, ferric oxide, nBF (normal-butylferrocene), DnBF (dinormal-butyl-ferrocene), FeO(OH), ferrous oxide, magnesium oxide, copper oxide (I), copper oxide (II), cobalt oxide, copper chromite, ferrocene, dimethylferrocene, ferrosilicon and activated carbon.

7. The disassemblable adhesive according to claim 1, wherein the adhesive further comprises an exothermic agent.

8. The disassemblable adhesive according to claim 7, wherein the exothermic agent is at least one member selected from the group consisting of a 3-azidomethyl-3-oxetane polymer (AMMO), a glycidylazido polymer (GAP), a 3,3-bisazidomethyloxetane polymer (BAMO), azodicarbonamide, a metal salt of azodicarbonamide, urea, guanidine nitrate, biscarbamoylhydrazine, p,p′-oxybisbenzenesulfonylhydrazide, dinitropentamethylenetetramine, p-toluenesulfonylhydrazide, benzenesulfonylhydrazide, dinitropentamethylenetetramine, trimethylenetrinitroamine (RDX), tetramethylenetetranitroamine (HMX), urazole, a triazole and a tetrazole.

9. An adhering method comprising adhering an adherend and an adherend with the disassemblable adhesive according to claim 1.

10. The adhering method according to claim 9, wherein one adherend is metal and the other adherend is FRP.

11. A disassembling method comprising carbonizing by external stimulation a binding site of an adhered structure adhered by the adhering method according to claim 9 to allow adhesion strength to disappear.

12. The disassembling method according to claim 11, wherein the external stimulation is heating.

13. The disassemblable adhesive according to claim 2, wherein the oxidant is a perchloric acid-based oxidant.

14. The disassemblable adhesive according to claim 13, wherein the particle size of the oxidant is 100 μm or less.

15. The disassemblable adhesive according to claim 14, wherein the adhesive further comprises a decomposition accelerator.

16. The disassemblable adhesive according to claim 15, wherein the decomposition accelerator is at least one member selected from the group consisting of a chromate, manganese oxide, ferric oxide, nBF (normal-butylferrocene), DnBF (dinormal-butyl-ferrocene), FeO(OH), ferrous oxide, magnesium oxide, copper oxide (I), copper oxide (II), cobalt oxide, copper chromite, ferrocene, dimethylferrocene, ferrosilicon and activated carbon.

17. The disassemblable adhesive according to claim 16, wherein the adhesive further comprises an exothermic agent.

18. The disassemblable adhesive according to claim 17, wherein the exothermic agent is at least one member selected from the group consisting of a 3-azidomethyl-3-oxetane polymer (AMMO), a glycidylazido polymer (GAP), a 3,3-bisazidomethyloxetane polymer (BAMO), azodicarbonamide, a metal salt of azodicarbonamide, urea, guanidine nitrate, biscarbamoylhydrazine, p,p′-oxybisbenzenesulfonylhydrazide, dinitropentamethylenetetramine, p-toluenesulfonylhydrazide, benzenesulfonylhydrazide, dinitropentamethylenetetramine, trimethylenetrinitroamine (RDX), tetramethylenetetranitroamine (HMX), urazole, a triazole and a tetrazole.

19. An adhering method comprising adhering an adherend and an adherend with the disassemblable adhesive according to claim 18.

20. The adhering method according to claim 19, wherein one adherend is metal and the other adherend is FRP.

21. A disassembling method comprising carbonizing by external stimulation a binding site of an adhered structure adhered by the adhering method according to claim 20 to allow adhesion strength to disappear.

22. The disassembling method according to claim 21, wherein the external stimulation is heating.
